(19) United States
(12) Patent Application Publication
(10) Pub. No.: US 2025/0336595 A1
(43) Pub. Date: Oct. 30, 2025

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Keisuke KUNIMORI, Nagaokakyo-shi (JP)

(73) Assignee: Murata Manufacturing Co., Ltd., Kyoto-fu (JP)

(21) Appl. No.: 19/072,715

(22) Filed: Mar. 6, 2025

(30) Foreign Application Priority Data
Apr. 25, 2024 (JP) 2024-071775

(51) Int. Cl. H01F 27/32; H01F 27/24

(52) U.S. Cl. CPC H01F 27/32; H01F 27/24

(57) ABSTRACT

A inductor component includes a base insulation layer having a base upper surface; a first wall portion on the base upper surface and extending around a turning axis in an up-down direction; a second wall portion on the base upper surface and extending parallel to the first wall portion around the turning axis; a wiring conductor on the base upper surface between the first and second wall portions and having a conductor upper surface opposite in the up-down direction to a surface of the wiring conductor in contact with the base insulation layer; a cover insulation layer laminated on the conductor upper surface; and a magnetic body. The cover insulation layer includes a cover portion overlapping the wiring conductor in plan view and a protruding portion on an opposite side of the first wall portion from the cover portion in a radial direction of the turning axis.

### CROSS-REFERENCE TO RELATED APPLICATION

This application claims benefit of priority to Japanese Patent Application No. 2024-071775, filed Apr. 25, 2024, the entire content of which is incorporated herein by reference.

### BACKGROUND

### Technical Field

The present disclosure relates to an inductor component.

### Background Art

The coil component in Japanese Unexamined Patent Application Publication No. 2022-152043 includes first, second, and third magnetic members, a plurality of conductor layers located between the first magnetic member and the second magnetic member, and a plurality of insulation resin layers each located between the conductor layers. The plurality of conductor layers each include a spiral pattern winding in a spiral shape. The third magnetic member is located in the inner-diameter region of the spiral pattern. The plurality of insulation resin layers include protruding portions protruding into the inner-diameter region.

### SUMMARY

The coil component in Japanese Unexamined Patent Application Publication No. 2022-152043 still has room for improvement in terms of reducing the direct current resistance while reducing damage to a cover insulation layer.

Accordingly, the present disclosure provides an inductor component in which the direct current resistance is reduced while damage to a cover insulation layer is reduced.

An inductor component according to an aspect of the present disclosure includes a base insulation layer having a base upper surface; a first wall portion located on the base upper surface and extending around a turning axis in an up-down direction intersecting the base upper surface; a second wall portion located on the base upper surface and extending parallel to the first wall portion around the turning axis; a wiring conductor located on the base upper surface between the first wall portion and the second wall portion and having a conductor upper surface opposite in the up-down direction to a surface of the wiring conductor in contact with the base insulation layer; a cover insulation layer laminated on the conductor upper surface; and a magnetic body covering the base insulation layer, the first wall portion, the second wall portion, the wiring conductor, and the cover insulation layer. The cover insulation layer includes a cover portion overlapping the wiring conductor in plan view in the up-down direction, and a protruding portion located on an opposite side of the first wall portion from the cover portion in a radial direction of the turning axis. A thickness of the protruding portion, the thickness being a dimension in the up-down direction, is greater than the thickness of the cover portion.

With the inductor component according to the aspect mentioned above, it is possible to reduce the direct current resistance while reducing damage to a cover insulation layer.

### BRIEF DESCRIPTION OF THE DRAWINGS

FIG. 1 is a plan view of an inductor component according to an aspect of the present disclosure;

FIG. 2 is a sectional view taken along line II-II in FIG. 1;

FIG. 3 is a plan-view schematic diagram for explaining a layer including a first inductor wire and a third inductor wire of the inductor component in FIG. 1;

FIG. 4 is a plan-view schematic diagram for explaining a layer including a second inductor wire and a fourth inductor wire of the inductor component in FIG. 1;

FIG. 5 is an enlarged sectional view of region Z1 illustrated in FIG. 2;

FIG. 6 is a sectional view taken along line VI-VI in FIG. 1;

FIG. 7 is an enlarged sectional view of region Z2 illustrated in FIG. 5;

FIG. 8 is an enlarged sectional view of region Z3 illustrated in FIG. 5;

FIG. 9 is an enlarged sectional view of region Z4 illustrated in FIG. 6;

FIG. 10 is a sectional view of a first modification example of the inductor component in FIG. 1;

FIG. 11 is a sectional view of a second modification example of the inductor component in FIG. 1;

FIG. 12 is a sectional view of a third modification example of the inductor component in FIG. 1;

FIG. 13 is a first diagram for explaining an example of a method of manufacturing the inductor component in FIG. 1;

FIG. 14 is a second diagram for explaining the example of the method of manufacturing the inductor component in FIG. 1;

FIG. 15 is a third diagram for explaining the example of the method of manufacturing the inductor component in FIG. 1;

FIG. 16 is a fourth diagram for explaining the example of the method of manufacturing the inductor component in FIG. 1;

FIG. 17 is a fifth diagram for explaining the example of the method of manufacturing the inductor component in FIG. 1;

FIG. 18 is a sixth diagram for explaining the example of the method of manufacturing the inductor component in FIG. 1;

FIG. 19 is a seventh diagram for explaining the example of the method of manufacturing the inductor component in FIG. 1;

FIG. 20 is an eighth diagram for explaining the example of the method of manufacturing the inductor component in FIG. 1;

FIG. 21 is a ninth diagram for explaining the example of the method of manufacturing the inductor component in FIG. 1; and

FIG. 22 is a tenth diagram for explaining the example of the method of manufacturing the inductor component in FIG. 1.

### DETAILED DESCRIPTION

Various aspects of the present disclosure will be described.

A first aspect of the present disclosure provides an inductor component including a base insulation layer having a base upper surface; a first wall portion located on the base upper surface and extending around a turning axis in an up-down direction intersecting the base upper surface; a second wall portion located on the base upper surface and extending parallel to the first wall portion around the turning axis; a wiring conductor located on the base upper surface between the first wall portion and the second wall portion and having a conductor upper surface opposite in the up-down direction to a surface of the wiring conductor in contact with the base insulation layer; a cover insulation layer laminated on the conductor upper surface; and a magnetic body covering the base insulation layer, the first wall portion, the second wall portion, the wiring conductor, and the cover insulation layer. The cover insulation layer includes a cover portion overlapping the wiring conductor in plan view in the up-down direction, and a protruding portion located on an opposite side of the first wall portion from the cover portion in a radial direction of the turning axis. A thickness of the protruding portion, the thickness being a dimension in the up-down direction, is greater than the thickness of the cover portion.

A second aspect of the present disclosure provides the inductor component according to the first aspect, in which the thickness of the first wall portion and the second wall portion is greater than the thickness of the wiring conductor.

A third aspect of the present disclosure provides the inductor component according to the first or second aspect, in which the first wall portion has an inner wall surface in contact with the wiring conductor and an outer wall surface opposite to the inner wall surface and in contact with the magnetic body, and the cover insulation layer has a cover side surface facing the radial direction and located closer to the second wall portion than the outer wall surface in the radial direction.

A fourth aspect of the present disclosure provides the inductor component according to any one of the first to third aspects, in which the cover insulation layer has a cover lower surface facing the base insulation layer in the up-down direction and a cover upper surface opposite to the cover lower surface, and the cover upper surface is smoother than the cover lower surface.

A fifth aspect of the present disclosure provides the inductor component according to the fourth aspect, in which the cover portion has a cover-portion lower surface in contact with the wiring conductor, the protruding portion has a protruding-portion lower surface facing the base insulation layer in the up-down direction, and a surface roughness of the cover-portion lower surface differs from a surface roughness of the protruding-portion lower surface.

A sixth aspect of the present disclosure provides the inductor component according to any one of the first to fifth aspects, in which the protruding portion has a protruding-portion side surface facing the radial direction, and the protruding-portion side surface includes a plurality of straight line portions having different inclination angles in a cross section intersecting an extending direction of the wiring conductor.

A seventh aspect of the present disclosure provides the inductor component according to any one of the first to sixth aspects, in which the protruding portion has a protruding-portion side surface facing the radial direction, and the protruding-portion side surface includes a straight line portion and a curved line portion in a cross section intersecting an extending direction of the wiring conductor.

An eighth aspect of the present disclosure provides the inductor component according to any one of the first to seventh aspects, in which the protruding portion has a protruding-portion lower surface facing the base insulation layer in the up-down direction, and the protruding-portion lower surface includes an inclined portion inclined upward as the inclined portion extends toward the first wall portion in the radial direction in a cross section intersecting an extending direction of the wiring conductor.

A ninth aspect of the present disclosure provides the inductor component according to any one of the first to eighth aspects, in which the cover insulation layer has a cover lower surface facing the base insulation layer in the up-down direction and a cover upper surface opposite to the cover lower surface. The inductor component further includes a third wall portion located on the cover upper surface and extending around the turning axis; a fourth wall portion located on the cover upper surface and extending parallel to the third wall portion around the turning axis; and an upper wiring conductor located on the cover upper surface between the third wall portion and the fourth wall portion and having an upper-conductor upper surface opposite in the up-down direction to a surface of the upper wiring conductor in contact with the cover insulation layer. The cover insulation layer contains inorganic filler, the cover insulation layer has a lower transparency than the first wall portion and the second wall portion, and the thickness of the cover insulation layer is less than the thickness of the first wall portion and the thickness of the second wall portion.

A tenth aspect of the present disclosure provides the inductor component according to any one of the first to ninth aspects, further including an external terminal located on an outer surface of the magnetic body; and a connection wire located in the magnetic body, extending in the up-down direction, and connecting the external terminal to the wiring conductor. A pad portion connected to the connection wire is located at an end portion of the wiring conductor in plan view.

An eleventh aspect of the present disclosure provides the inductor component according to the tenth aspect, in which the cover portion includes a first portion in contact with the pad portion in the up-down direction, and a second portion in contact with a portion of the wiring conductor other than the pad portion in the up-down direction. The thickness of the first portion is less than the thickness of the second portion.

A twelfth aspect of the present disclosure provides the inductor component according to any one of the first to eleventh aspects, in which the protruding portion is located closer to the turning axis than the first wall portion in the radial direction, the cover insulation layer further includes an outward protruding portion located on an opposite side of the first wall portion from the cover portion in the radial direction and located farther from the turning axis than the first wall portion, and the thickness of the outward protruding portion differs from the thickness of the protruding portion.

A thirteenth aspect of the present disclosure provides the inductor component according to the twelfth aspect, in which the thickness of the protruding portion is greater than the thickness of the outward protruding portion.

A fourteenth aspect of the present disclosure provides the inductor component according to any one of the first to thirteenth aspects, in which the cover insulation layer has a cover lower surface facing the base insulation layer in the up-down direction and a cover upper surface opposite to the cover lower surface. The inductor component further includes a third wall portion located on the cover upper surface and extending around the turning axis; a fourth wall portion located on the cover upper surface and extending parallel to the third wall portion around the turning axis; an upper wiring conductor located on the cover upper surface between the third wall portion and the fourth wall portion and having an upper-conductor upper surface opposite in the up-down direction to a surface of the upper wiring conductor in contact with the cover insulation layer; and an upper cover insulation layer laminated on the upper-conductor upper surface. The upper cover insulation layer includes an upper cover portion overlapping the upper wiring conductor in plan view, and an upper protruding portion located on an opposite side of the third wall portion from the upper cover portion in the radial direction. The thickness of the upper protruding portion differs from the thickness of the protruding portion.

A fifteenth aspect of the present disclosure provides the inductor component according to the fourteenth aspect, in which the thickness of the upper protruding portion is greater than the thickness of the protruding portion.

A sixteenth aspect of the present disclosure provides the inductor component according to any one of the first to fifteenth aspects, in which the cover insulation layer has a cover lower surface facing the base insulation layer in the up-down direction and a cover upper surface opposite to the cover lower surface. The inductor component further includes a third wall portion located on the cover upper surface and extending around the turning axis; a fourth wall portion located on the cover upper surface and extending parallel to the third wall portion around the turning axis; and an upper wiring conductor located on the cover upper surface between the third wall portion and the fourth wall portion and having an upper-conductor upper surface opposite in the up-down direction to a surface of the upper wiring conductor in contact with the cover insulation layer. Also, in the cover insulation layer, a portion between the first wall portion or the second wall portion and the third wall portion or the fourth wall portion in the up-down direction includes a portion of the cover insulation layer having a least thickness.

Hereinafter, an embodiment of the present disclosure will be described with reference to drawings. The following description is not intended to limit the present disclosure, is merely to show examples in nature, and can be changed as appropriate within a range not departing from the spirit of the present disclosure. The drawings are schematic, and hence, the ratios of dimensions or the like are not necessarily consistent with actual ones. In the following description, terms such as “about”, “nearly”, or “approximately” denote that the values, the shapes, or the like following these terms include the acceptable range of error determined by those skilled in the art.

In the following description, terms indicating specific directions or positions (for example, terms including “upper”, “lower”, “right”, and “left”) are used as necessary. However, use of those terms is for facilitating understanding of the present disclosure with reference to drawings, and the meanings of those terms are not intended to limit the technical scope of the present disclosure.

In the following description, “thickness” and “height” are dimensions of members in the up-down direction Z unless otherwise noted.

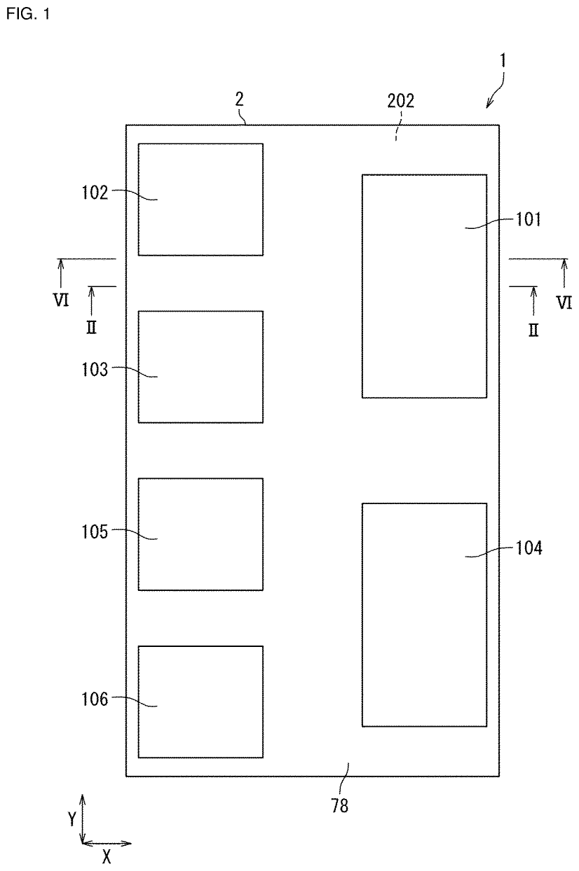

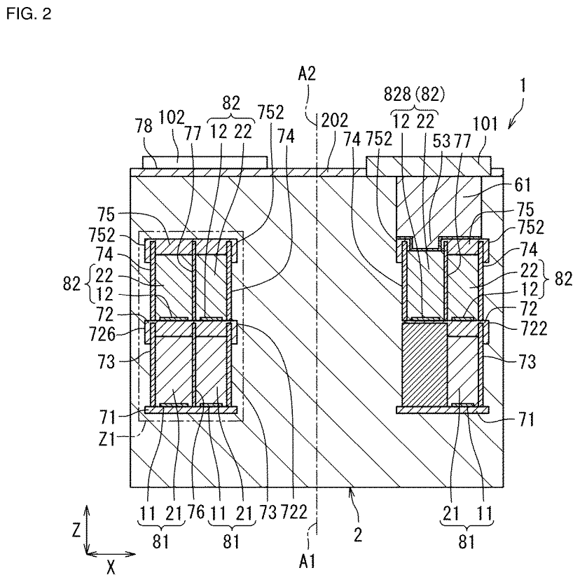

As illustrated in FIGS. 1 and 2, an inductor component 1 of the present disclosure includes a base insulation layer 71, insulating first and second wall portions 73 and 76, a first conductor layer 11, a first inductor wire 21, and a cover insulation layer 72. Above the cover insulation layer 72 are located insulating third and fourth wall portions 74 and 77, a second conductor layer 12, a second inductor wire 22, and an upper cover insulation layer 75. The members mentioned above are located inside a magnetic body 2 containing a magnetic material.

In this aspect, the magnetic body 2 has an approximately rectangular parallelepiped shape. The magnetic body 2 has a size of, for example, 1.2×2.1×0.55 mm. The magnetic body 2 has an outer surface intersecting (for example, orthogonal to) the up-down direction, for example, the Z direction. Hereinafter, this outer surface is sometimes also referred to as a main surface 202. As illustrated in FIG. 1, the main surface 202 has a plurality of external terminals 101 to 106 and an insulation layer 78. The insulation layer 78 has, for example, a thickness of 10 μm. The external terminals 101 to 106 are composed of, for example, a laminate of Cu/Ni/Au (=5/5/0.1 um).

The magnetic body 2 is formed of, for example, a composite containing a resin and inorganic filler (for example, a composite containing epoxy and FeSiCr). Examples of the resin include epoxy, acrylic, liquid crystal polymers, phenol, and combinations of these, and the resin provides the magnetic body 2 with a strength and a good insulating property. Examples of the inorganic filler included in the magnetic body 2 include metal magnetic powder (for example, materials such as Fe, FeSi-based, FeSiCr-based, and FeNi-based materials containing Fe element as the primary component). In this case, the magnetic body 2 has a high magnetic permeability and a high magnetic saturation density. The inorganic filler does not have to be magnetic powder of one kind, may be magnetic powder composed of a combination of different compositions and different particle sizes, and may contain insulating filler such as silica to achieve a sufficient coefficient of linear expansion and a sufficient insulating property.

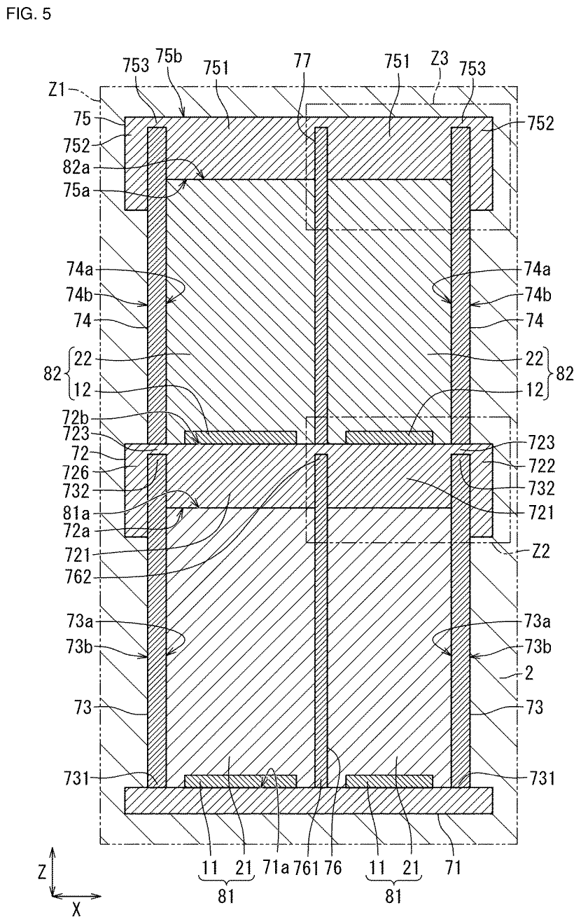

As illustrated in FIG. 2, the base insulation layer 71, the cover insulation layer 72, and the upper cover insulation layer 75 each have an approximately plate shape intersecting the up-down direction Z. The cover insulation layer 72 is located above the base insulation layer 71. The upper cover insulation layer 75 is located above the cover insulation layer 72. As illustrated in FIG. 5, the base insulation layer 71 has a base upper surface 71a facing the cover insulation layer 72. The cover insulation layer 72 has a cover lower surface 72a facing the base insulation layer 71 and a cover upper surface 72b opposite to the cover lower surface 72a. The upper cover insulation layer 75 has an upper-cover lower surface 75a facing the cover insulation layer 72 and an upper-cover upper surface 75b opposite to the upper-cover lower surface 75a.

As an example, the cover upper surface 72b is smoother than the cover lower surface 72a. In other words, the cover upper surface 72b has a smaller surface roughness than the cover lower surface 72a. The upper-cover upper surface 75b is smoother than the upper-cover lower surface 75a. In other words, the upper-cover upper surface 75b has a smaller surface roughness than the upper-cover lower surface 75a. The surface roughness is, for example, line edge roughness (LER). A method of measuring LER will be described. An image of a cross section of the inductor component 1 intersecting the extending direction of a wiring conductor 81 is obtained. In this image, edge points of the measurement surface (for example, the cover lower surface 72a or the cover upper surface 72b) are detected. The deviation of each edge point from the approximate line of the edge points obtained by the least square method is calculated. The average value of the positional deviations is regarded as the LER of the measurement surface.

The first conductor layer 11 is located on the base upper surface 71a. The second conductor layer 12 is located on the cover upper surface 72b. The first inductor wire 21 is located over the first conductor layer 11. The first inductor wire 21 is located between the first conductor layer 11 and the cover insulation layer 72 in the up-down direction Z. The second inductor wire 22 is located over the second conductor layer 12. The second inductor wire 22 is located on the opposite side of the cover insulation layer 72 from the first inductor wire 21.

As an example, the first conductor layer 11 has a thickness less than 1.0 μm which is the dimension in the up-down direction Z. The thickness of the first conductor layer 11 is less than 1/100 of the thickness of the first inductor wire 21. The second conductor layer 12 may also have a configuration the same as or similar to that of the first conductor layer 11. Specifically, the thickness of the second conductor layer 12 may be less than 1.0 μm and less than 1/100 of the thickness of the second inductor wire 22.

As an example, each of the first conductor layer 11 and the second conductor layer 12 includes a single layer (Cu or Ag) or a plurality of layers (for example, Ti/Cu) laminated in the up-down direction Z.

The first conductor layer 11 and the first inductor wire 21 correspond to a “wiring conductor” in the present disclosure. The second conductor layer 12 and the second inductor wire 22 correspond to an “upper wiring conductor” in the present disclosure. In the following description, the first conductor layer 11 and the first inductor wire 21 are sometimes collectively referred to as the wiring conductor 81, and the second conductor layer 12 and the second inductor wire 22 are sometimes collectively referred to as an upper wiring conductor 82.

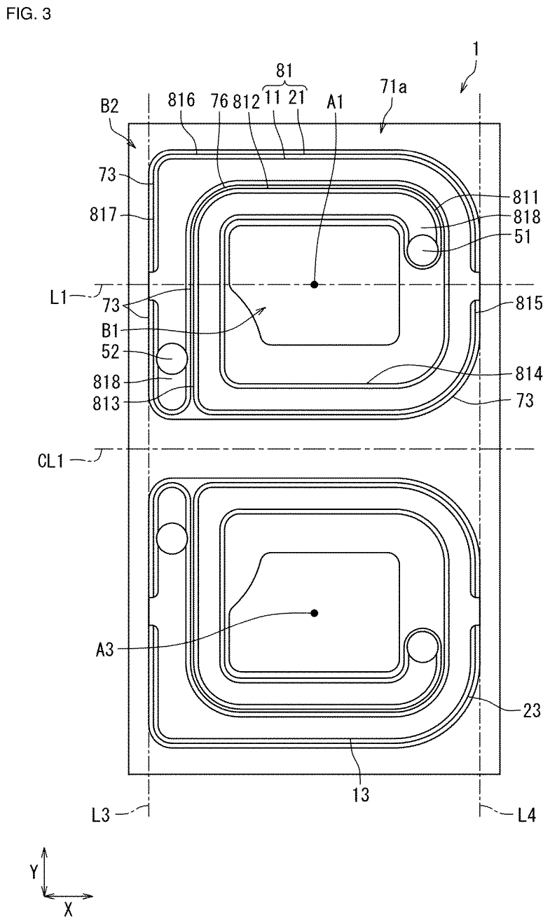

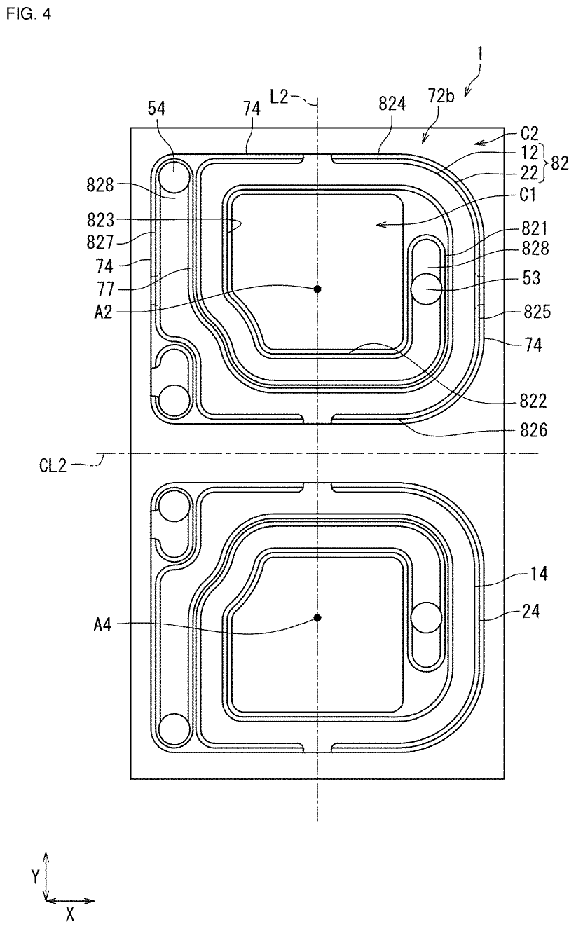

As illustrated in FIG. 3, the wiring conductor 81 extends around a first turning axis A1 intersecting (for example, orthogonal to) the base upper surface 71a. As illustrated in FIG. 4, the upper wiring conductor 82 extends around a second turning axis A2 intersecting (for example, orthogonal to) the cover upper surface 72b.

As illustrated in FIG. 5, the wiring conductor 81 has a conductor upper surface 81a which is opposite in the up-down direction Z to the surface in contact with the base insulation layer 71. The cover insulation layer 72 is laminated on the conductor upper surface 81a. In other words, the conductor upper surface 81a is covered with the cover insulation layer 72. The upper wiring conductor 82 has an upper-conductor upper surface 82a which is opposite in the up-down direction Z to the surface in contact with the cover insulation layer 72. The upper cover insulation layer 75 is laminated on the upper-conductor upper surface 82a. In other words, the upper-conductor upper surface 82a is covered with the upper cover insulation layer 75.

As illustrated in FIGS. 2 and 3, the first wall portion 73 and the second wall portion 76 are located on both sides of the wiring conductor 81 in the radial direction of the first turning axis A1. In other words, the wiring conductor 81 is located on the base upper surface 71a between the first wall portion 73 and the second wall portion 76. As illustrated in FIG. 3, the first wall portion 73 and the second wall portion 76 extend along the wiring conductor 81 around the first turning axis A1 on the base upper surface 71a. Note that the radial direction of the first turning axis A1 is, for example, a direction intersecting both the up-down direction Z and the extending direction of the wiring conductor 81. In other words, the radial direction of the first turning axis A1 is a direction extending radially from the first turning axis A1 or a direction converging toward the first turning axis A1 when viewed in the direction parallel to the first turning axis A1.

As illustrated in FIG. 5, the first wall portion 73 and the second wall portion 76 extend upward from the base upper surface 71a. The first wall portion 73 has an inner wall surface 73a in contact with the wiring conductor 81 and an outer wall surface 73b opposite to the inner wall surface 73a and in contact with the magnetic body 2. The second wall portion 76 is located on the opposite side of the wiring conductor 81 from the first wall portion 73 in the radial direction. The second wall portion 76 may be in contact with the wiring conductor 81 on both the two wall surfaces facing the radial direction. The second wall portion 76 may be in contact with the wiring conductor 81 on one of the two wall surfaces and be in contact with the magnetic body 2 on the other wall surface.

The first wall portion 73 has a lower edge portion 731 in contact with the base upper surface 71a and an upper edge portion 732 located opposite to the lower edge portion 731 in the up-down direction Z. The first wall portion 73 has a thickness between the lower edge portion 731 and the upper edge portion 732 in the up-down direction Z. The second wall portion 76 has a lower edge portion 761 in contact with the base upper surface 71a and an upper edge portion 762 located opposite to the lower edge portion 761 in the up-down direction Z. The second wall portion 76 has a thickness between the lower edge portion 761 and the upper edge portion 762 in the up-down direction Z. In this aspect, the upper edge portions 732 and 762 are located above the wiring conductor 81.

As illustrated in FIGS. 2 and 4, the third wall portion 74 and the fourth wall portion 77 are located on both sides of the upper wiring conductor 82 in the radial direction of the second turning axis A2. In other words, the upper wiring conductor 82 is located on the cover upper surface 72b between the third wall portion 74 and the fourth wall portion 77. As illustrated in FIG. 4, the third wall portion 74 and the fourth wall portion 77 extend along the upper wiring conductor 82 around the second turning axis A2 on the cover upper surface 72b. Note that the radial direction of the second turning axis A2 is, for example, a direction intersecting both the up-down direction Z and the extending direction of the upper wiring conductor 82. In other words, the radial direction of the second turning axis A2 is a direction extending radially from the second turning axis A2 or a direction converging toward the second turning axis A2 when viewed in the direction parallel to the second turning axis A2.

The third wall portion 74 and the fourth wall portion 77 extend upward from the cover upper surface 72b. As illustrated in FIG. 5, the third wall portion 74 has an upper inner wall surface 74a in contact with the upper wiring conductor 82 and an upper outer wall surface 74b opposite to the upper inner wall surface 74a and in contact with the magnetic body 2. The fourth wall portion 77 is located on the opposite side of the upper wiring conductor 82 from the third wall portion 74 in the radial direction. The fourth wall portion 77 may be in contact with the upper wiring conductor 82 on both the two wall surfaces facing the radial direction. The fourth wall portion 77 may be in contact with the upper wiring conductor 82 on one of the two wall surfaces and be in contact with the magnetic body 2 on the other wall surface.

As illustrated in FIGS. 3 and 4, the inductor component 1 includes a third conductor layer 13, a fourth conductor layer 14, a third inductor wire 23 located over the third conductor layer 13, and a fourth inductor wire 24 located over the fourth conductor layer 14. The third conductor layer 13 is located on the base upper surface 71a and electrically separated from the first conductor layer 11. The fourth conductor layer 14 is located on the cover upper surface 72b and electrically separated from the second conductor layer 12.

As illustrated in FIG. 3, the third conductor layer 13, when viewed in the up-down direction Z, is located symmetric to the first conductor layer 11 with respect to a first center line CL1 extending on the base upper surface 71a in the lateral direction (for example, the X direction) of the inductor component 1 and has the shape symmetric to the first conductor layer 11 with respect to the first center line CL1. The third inductor wire 23 is located symmetric to the first inductor wire 21 with respect to the first center line CL1 and has the shape symmetric to the first inductor wire 21 with respect to the first center line CL1. The third inductor wire 23 is located around a third turning axis A3 which is located symmetric to the first turning axis A1 with respect to the first center line CL1.

As illustrated in FIG. 4, the fourth conductor layer 14, when viewed in the up-down direction Z, is located symmetric to the second conductor layer 12 with respect to a second center line CL2 extending on the cover upper surface 72b in the lateral direction X and has the shape symmetric to the second conductor layer 12 with respect to the second center line CL2. The fourth inductor wire 24 is located symmetric to the second inductor wire 22 with respect to the second center line CL2 and has the shape symmetric to the second inductor wire 22 with respect to the second center line CL2. The fourth inductor wire 24 is located around a fourth turning axis A4 which is located symmetric to the second turning axis A2 with respect to the second center line CL2.

As an example, the first turning axis A1 and the second turning axis A2 are located on the same straight line (see FIG. 2) and the third turning axis A3 and the fourth turning axis A4 are located on the same straight line. The first center line CL1 and the second center line CL2 are located approximately at the center of the inductor component 1 in the longitudinal direction (for example, the Y direction) when viewed in the up-down direction Z.

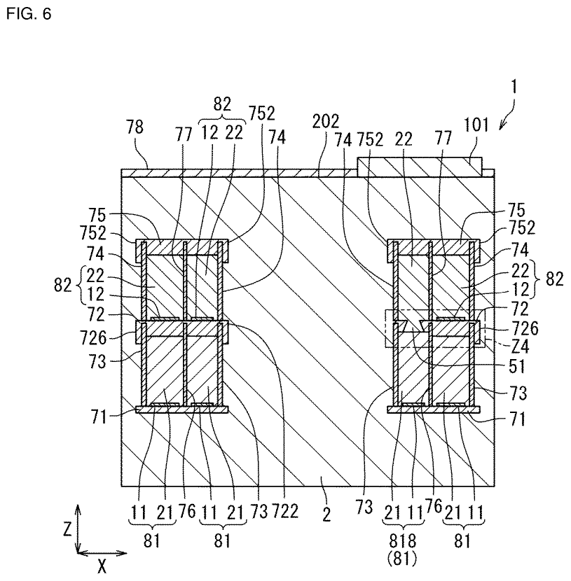

As illustrated in FIG. 3, the wiring conductor 81 has a spiral shape when viewed in the up-down direction Z, as an example. At the two respective ends of the wiring conductor 81 in the extending direction of the wiring conductor 81 are located two pad portions 818. As illustrated in FIG. 6, for example, the thickness of the pad portion 818 is greater than the thickness of the portion of the wiring conductor 81 other than the pad portions 818 (for example, the portion of the wiring conductor 81 excluding the pad portions 818). In this aspect, the two respective pad portions 818 are connected to two via conductors 51 and 52. The first inductor wire 21 is composed of, for example, a laminate of L/S/t (=100/10/150 μm).

The wiring conductor 81 includes a first portion 811 to a seventh portion 817.

The first portion 811 extends from the end portion connected to the via conductor 51 and located close to the first turning axis A1, in the longitudinal direction Y away from the first center line CL1. As an example, the portion of the first portion 811 connected to the via conductor 51 serves as a first output portion.

The second portion 812 extends in the lateral direction X from the end portion, farther from the first center line CL1, of the two ends of the first portion 811 in the longitudinal direction Y.

The third portion 813 extends in the longitudinal direction Y toward the first center line CL1 from the end portion, farther from the first portion 811, of the two ends of the second portion 812 in the lateral direction X.

The fourth portion 814 extends in the lateral direction X toward the first portion 811 from the end portion, farther from the second portion 812, of the two ends of the third portion 813 in the longitudinal direction Y.

The fifth portion 815 extends in the longitudinal direction Y away from the first center line CL1 from the end portion, farther from the third portion 813, of the two ends of the fourth portion 814 in the lateral direction X. The fifth portion 815 is located farther from the first turning axis A1 than the first portion 811 in the lateral direction X, and part of the fifth portion 815 overlaps the first portion 811 when viewed in the lateral direction X. The portion between the fifth portion 815 and the first portion 811 is insulated by the second wall portion 76.

The sixth portion 816 extends in the lateral direction X toward the third portion 813 from the end portion, farther from the fourth portion 814, of the two ends of the fifth portion 815 in the longitudinal direction Y. The sixth portion 816 is located farther from the first turning axis A1 than the second portion 812 in the longitudinal direction Y, and part of the sixth portion 816 overlaps the second portion 812 when viewed in the longitudinal direction Y. The portion between the sixth portion 816 and the second portion 812 is insulated by the second wall portion 76.

The seventh portion 817 extends in the longitudinal direction Y toward the first center line CL1 from the end portion, farther from the fifth portion 815, of the two ends of the sixth portion 816 in the lateral direction X. The seventh portion 817 is located farther from the first turning axis A1 than the third portion 813 in the lateral direction X, and part of the seventh portion 817 overlaps the third portion 813 when viewed in the lateral direction X. The portion between the seventh portion 817 and the third portion 813 is insulated by the second wall portion 76. The end portion, closer to the first center line CL1, of the two ends of the seventh portion 817 in the longitudinal direction Y is connected to the via conductor 52. As an example, the portion of the seventh portion 817 connected to the via conductor 52 serves as a first input portion.

As illustrated in FIG. 3, the magnetic body 2 contains a first region B1 closer to the first turning axis A1 than the wiring conductor 81 and a second region B2 farther from the first turning axis A1 than the wiring conductor 81. In this aspect, the first region B1 is surrounded by the first portion 811 to the fourth portion 814 and part of the fifth portion 815 of the wiring conductor 81 when viewed in the up-down direction Z.

As illustrated in FIG. 4, the upper wiring conductor 82 is located around the second turning axis A2 in the up-down direction Z. In this aspect, the upper wiring conductor 82 has a spiral shape in the direction opposite to the wiring conductor 81 when viewed in the up-down direction Z.

The upper wiring conductor 82 is composed of, for example, a laminate of L/S/t (=100/10/150 um). At the two ends of the upper wiring conductor 82 in the extending direction of the upper wiring conductor 82 are located two pad portions 828. For example, the thickness of the pad portion 828 is greater than the thickness of the portion of the upper wiring conductor 82 other than the pad portions 828, for example, the portion of the upper wiring conductor 82 excluding the pad portions 828. In this aspect, the two pad portions 828 are connected to via conductors 53 and 54 extending in the up-down direction Z. As illustrated in FIG. 2, the via conductor 53 connects the upper wiring conductor 82 to a connection wire 61. The connection wire 61 extends in the magnetic body 2 in the up-down direction Z and connects the upper wiring conductor 82 to the external terminal 101 through the via conductor 53. Between the upper wiring conductor 82 and the connection wire 61 in the up-down direction Z is located the upper cover insulation layer 75. The upper cover insulation layer 75 has, for example, a thickness of 15 μm.

As illustrated in FIG. 4, the upper wiring conductor 82 includes a first portion 821 to a seventh portion 827.

The first portion 821 extends from the end portion connected to the via conductor 53 and located close to the first turning axis A1, in the longitudinal direction Y toward the second center line CL2. As an example, the portion of the first portion 821 connected to the via conductor 53 serves as a second output portion. When viewed in the up-down direction Z, the via conductor 51 and the via conductor 53 are adjacent to each other. In other words, the first output portion and the second output portion are adjacent to each other. The statement “the first output portion and the second output portion are adjacent to each other” refers to, for example, a state in which the via conductor 51 and the via conductor 53 are located within a very small region (for example, within 20 μm) when viewed in the up-down direction Z. In this aspect, the distance between the via conductor 51 and the via conductor 53 is approximately 10 μm when viewed in the up-down direction Z.

The second portion 822 extends in the lateral direction X from the end portion, closer to the second center line CL2, of the two ends of the first portion 821 in the longitudinal direction Y.

The third portion 823 extends in the longitudinal direction Y away from the second center line CL2 from the end portion, farther from the first portion 821, of the two ends of the second portion 822 in the lateral direction X.

The fourth portion 824 extends in the lateral direction X toward the first portion 821 from the end portion, farther from the second portion 822, of the two ends of the third portion 823 in the longitudinal direction Y.

The fifth portion 825 extends in the longitudinal direction Y toward the second center line CL2 from the end portion, farther from the third portion 823, of the two ends of the fourth portion 824 in the lateral direction X. The fifth portion 825 is located farther from the second turning axis A2 than the first portion 821 in the lateral direction X, and part of the fifth portion 825 overlaps the first portion 821 when viewed in the lateral direction X. The portion between the fifth portion 825 and the first portion 821 is insulated by the fourth wall portion 77.

The sixth portion 826 extends in the lateral direction X toward the third portion 823 from the end portion, farther from the fourth portion 824, of the two ends of the fifth portion 825 in the longitudinal direction Y. The sixth portion 826 is located farther from the second turning axis A2 than the second portion 822 in the longitudinal direction Y, and part of the sixth portion 826 overlaps the second portion 822 when viewed in the longitudinal direction Y. The portion between the sixth portion 826 and the second portion 822 is insulated by the fourth wall portion 77.

The seventh portion 827 extends in the longitudinal direction Y away from the second center line CL2 from the end portion, farther from the fifth portion 825, of the two ends of the sixth portion 826 in the lateral direction X. The seventh portion 827 is located farther from the second turning axis A2 than the third portion 823 in the lateral direction X, and part of the seventh portion 827 overlaps the third portion 823 when viewed in the lateral direction X. The portion between the seventh portion 827 and the third portion 823 is insulated by the fourth wall portion 77. The end portion closer to the second center line CL2 (specifically, a pad portion 828) of the two ends of the seventh portion 827 in the longitudinal direction Y is connected to the via conductor 54. As an example, the portion of the seventh portion 827 connected to the via conductor 54 serves as a second input portion. As illustrated in FIGS. 3 and 4, when viewed in the up-down direction Z, the via conductor 52 and the via conductor 54 are away from each other with a certain distance in the longitudinal direction Y. In other words, the first input portion and the second input portion are away from each other in the longitudinal direction Y. In the case in which the via conductor 52 and the via conductor 54 are away from each other with a distance of 200 μm or more (for example, 500 μm) when viewed in the up-down direction Z, the first input portion and the second input portion can be separated.

As illustrated in FIG. 4, the magnetic body 2 contains a first region C1 closer to the second turning axis A2 than the upper wiring conductor 82 and a second region C2 farther from the second turning axis A2 than the upper wiring conductor 82. In this aspect, the first region C1 is surrounded by the first portion 821 to the fifth portion 825 of the upper wiring conductor 82 when viewed in the up-down direction Z.

As illustrated in FIG. 5, the cover insulation layer 72 extends over the conductor upper surface 81a, the upper edge portion 732 of the first wall portion 73, and the upper edge portion 762 of the second wall portion 76. For example, the cover insulation layer 72 has a lower transparency than the first wall portion 73 and the second wall portion 76. The transparency refers to, for example, visible light transmittance. A method of measuring visible light transmittance will be described. In measurement of visible light transmittance, a measurement target having a specified thickness (for example, a cover insulation layer 72, a first wall portion 73, or a second wall portion 76) is used. The specified thickness is, for example, 20 μm. One surface of the measurement target in the thickness direction is irradiated with visible light. A light receiver, which is placed on the other surface side of the measurement target in the thickness direction, measures the intensity of the light transmitted through the measurement target. The ratio of the intensity of the transmitted light to the intensity of the visible light with which the one surface is irradiated is calculated. This ratio is converted to a value per 20 μm of the thickness of the measurement target, and the value obtained by the conversion is regarded as the visible light transmittance.

As an example, the cover insulation layer 72 and the upper cover insulation layer 75 are composed of an epoxy-based insulating material with inorganic filler, and the first to fourth wall portions 73, 76, 74, and 77 are composed of an acrylic-based insulating material. The inorganic filler is composed of, for example, silica, calcium carbonate, titanium oxide, or the like. It is preferable that the particle size (D50) of the inorganic filler contained in the cover insulation layer 72 be sufficiently smaller than the thickness of a cover portion 721 described later. For example, the particle size of the inorganic filler is 1/10 or less of the thickness of the cover portion 721 or is 1 μm or less. The first to fourth wall portions 73, 76, 74, and 77 need not contain organic filler. In the case in which the first to fourth wall portions 73, 76, 74, and 77 do not contain inorganic filler, the degradation in the molding precision of the first to the fourth wall portions 73, 76, 74, and 77 is reduced.

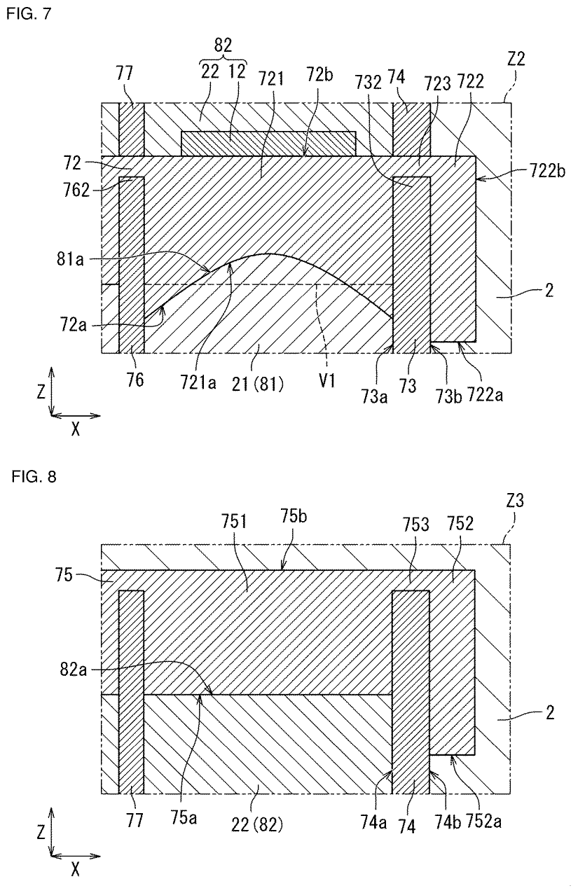

As illustrated in FIG. 7, the cover insulation layer 72 includes the cover portion 721, a protruding portion 722, and an intermediate portion 723 located between the cover portion 721 and the protruding portion 722 in the radial direction of the first turning axis A1 (the X direction in FIG. 7). The cover portion 721 is the portion overlapping the wiring conductor 81 in plan view in the up-down direction Z. The protruding portion 722 is the portion located on the opposite side of the first wall portion 73 from the cover portion 721 in the radial direction. The intermediate portion 723 is the portion located between the inner wall surface 73a and the outer wall surface 73b of the first wall portion 73 in plan view.

The cover portion 721 has a cover-portion lower surface 721a in contact with the wiring conductor 81. The protruding portion 722 has a protruding-portion lower surface 722a facing the base insulation layer 71 (see FIG. 5) in the up-down direction Z and a protruding-portion side surface 722b connecting the protruding-portion lower surface 722a and the cover upper surface 72b and facing the radial direction. The surface roughness of the protruding-portion lower surface 722a differs from the surface roughness of the cover-portion lower surface 721a. As an example, the surface roughness of the cover-portion lower surface 721a is larger than the surface roughness of the protruding-portion lower surface 722a.

In this aspect, the protruding portion 722 is located closer to the first turning axis A1 than the first wall portion 73 in the radial direction of the first turning axis A1. In other words, the protruding portion 722 is located in the first region B1 of the magnetic body 2.

The thickness of the protruding portion 722 is greater than the thickness of the cover portion 721. The thickness of the protruding portion 722 is the dimension between the height position of the cover upper surface 72b and the height position of the protruding-portion lower surface 722a in the up-down direction Z. However, in the case in which the protruding-portion lower surface 722a is not flat in a cross section of the wiring conductor 81, the height position of the straight line parallel to the main surface 202 and having the smallest difference from the actual protruding-portion lower surface 722a based on the least square method is regarded as the height position of the protruding-portion lower surface 722a. Note that the cross section of the wiring conductor 81 refers to a cross section intersecting (for example, orthogonal to) the extending direction of the wiring conductor 81.

The thickness of the cover portion 721 is the dimension between the height position of the cover upper surface 72b and the height position of the cover lower surface 72a (for example, the height position of the conductor upper surface 81a) in the up-down direction Z. However, in the case in which the cover lower surface 72a is not flat in a cross section of the wiring conductor 81 (see FIG. 7), the height position of the straight line V1 that is parallel to the main surface 202 and has the smallest difference from the actual cover lower surface 72a based on the least square method is regarded as the height position of the cover lower surface 72a. In the example illustrated in FIG. 7, the cover lower surface 72a is curved to protrude upward. In an example, the thickness of the cover portion 721 is less than the thickness of the first wall portion 73 and the thickness of the second wall portion 76. In this aspect, the thickness of the cover portion 721 is 15 μm, and the thickness of the first wall portion 73 and the second wall portion 76 is 165 μm. Note that in FIGS. 2, 5, 6, and 15 to 22, illustration of the curved shape of the conductor upper surface 81a is omitted, and the conductor upper surface 81a is depicted to be flat. In the cross sections illustrated in FIGS. 2, 5, 6, and 15 to 22, the conductor upper surface 81a may have the same shape or different shapes. Similarly, the upper-conductor upper surface 82a may have the same shape or different shapes in the cross sections mentioned above.

In this aspect, the intermediate portion 723 is the portion between the first wall portion 73 and the third wall portion 74 in the up-down direction Z. For example, the intermediate portion 723 includes the portion of the cover insulation layer 72 having the least thickness. In other words, the thickness of the intermediate portion 723 is less than the thickness of the cover portion 721.

As illustrated in FIG. 5, the upper cover insulation layer 75 extends over the upper-conductor upper surface 82a, the third wall portion 74, and the fourth wall portion 77. As illustrated in FIG. 8, the upper cover insulation layer 75 includes an upper cover portion 751, an upper protruding portion 752, and an intermediate portion 753 located between the upper cover portion 751 and the upper protruding portion 752 in the radial direction of the second turning axis A2 (the X direction in FIG. 8). The upper cover portion 751 is the portion overlapping the upper wiring conductor 82 in plan view. The upper protruding portion 752 is the portion located on the opposite side of the third wall portion 74 from the upper cover portion 751 in the radial direction. The upper protruding portion 752 has an upper-protruding-portion lower surface 752a facing the base insulation layer 71 in the up-down direction Z.

The thickness of the upper protruding portion 752 is greater than the thickness of the upper cover portion 751. The thickness of the upper protruding portion 752 is the dimension between the height position of the upper-cover upper surface 75b and the height position of the upper-protruding-portion lower surface 752a. Note that in the case in which the upper-protruding-portion lower surface 752a is not flat in a cross section of the upper wiring conductor 82, the height position of the straight line parallel to the main surface 202 and having the smallest difference from the actual upper-protruding-portion lower surface 752a based on the least square method is regarded as the height position of the upper-protruding-portion lower surface 752a.

For example, the thickness of the upper protruding portion 752 differs from the thickness of the protruding portion 722. In the present aspect, the thickness of the upper protruding portion 752 is greater than the thickness of the protruding portion 722.

The thickness of the upper cover portion 751 is the dimension between the height position of the upper-cover upper surface 75b and the height position of the upper-cover lower surface 75a (for example, the height position of the upper-conductor upper surface 82a). However, in the case in which the upper-cover lower surface 75a is not flat in a cross section of the upper wiring conductor 82 (see FIG. 8), the height position of the straight line parallel to the main surface 202 and having the smallest difference from the actual upper-cover lower surface 75a based on the least square method is regarded as the height position of the upper-cover lower surface 75a.

In this aspect, the thickness of the upper cover portion 751 is greater than the thickness of the cover portion 721 (see FIG. 7).

In this aspect, the intermediate portion 753 is the portion overlapping the third wall portion 74 in plan view. For example, the intermediate portion 753 includes the portion of the upper cover insulation layer 75 having the least thickness. In other words, the thickness of the intermediate portion 753 is less than the thickness of the upper cover portion 751.

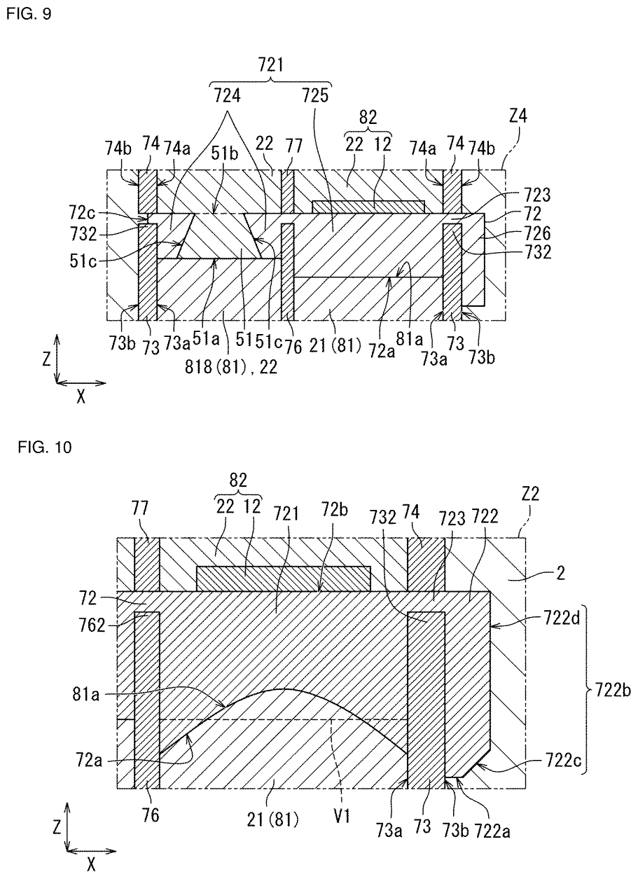

As illustrated in FIG. 6, the cover insulation layer 72 has the via conductor 51 passing through the cover insulation layer 72 in the up-down direction Z and connecting the pad portion 818 of the wiring conductor 81 to the upper wiring conductor 82. As illustrated in FIG. 9, the via conductor 51 has a tapered shape that narrows as it extends from the wiring conductor 81 toward the upper wiring conductor 82 in the up-down direction Z. In other words, the contact surface 51a of the via conductor 51 with the wiring conductor 81 is greater than the contact surface 51b of the via conductor 51 with the upper wiring conductor 82. The via conductor 51 has a via side surface 51c facing the radial direction and in contact with the cover insulation layer 72. In a cross section of the wiring conductor 81, the inclination angle of the via side surface 51c relative to the up-down direction Z is, for example, greater than 0 degrees and less than or equal to 35 degrees (i.e., from greater than 0 degrees to 35 degrees).

As illustrated in FIG. 6, the thickness of the wiring conductor 81 is greater in the pad portion 818 than in the portion other than the pad portions 818. As an example, the thickness of the pad portion 818 is greater than the portion of the wiring conductor 81 excluding the pad portions 818.

As illustrated in FIG. 9, the cover portion 721 includes a first portion 724 in contact with the pad portion 818 and a second portion 725 in contact with the portion of the wiring conductor 81 other than the pad portions 818. The thickness of the first portion 724 is less than the thickness of the second portion 725.

The cover insulation layer 72 has a cover side surface 72c facing the radial direction and located closer to the second wall portion 76 than the outer wall surface 73b in the radial direction. As an example, the cover side surface 72c is located between the outer wall surface 73b and the inner wall surface 73a in the radial direction. The cover side surface 72c is located at the portion of the cover insulation layer 72 excluding the protruding portion 722.

The cover insulation layer 72 includes, in addition to the protruding portion 722, an outward protruding portion 726 located on the opposite side of the first wall portion 73 from the cover portion 721 in the radial direction of the first turning axis A1. The outward protruding portion 726 is located farther from the first turning axis A1 than the first wall portion 73 in the radial direction of the first turning axis A1. The thickness of the outward protruding portion 726 is larger than the thickness of the cover portion 721. For example, the thickness of the outward protruding portion 726 differs from the thickness of the protruding portion 722. In this aspect, the thickness of the protruding portion 722 is greater than the thickness of the outward protruding portion 726.

A modification example of the protruding portion 722 will be described. In a modification example illustrated in FIG. 10, the protruding-portion side surface 722b includes a plurality of straight line portions having different inclination angles in a cross section of the wiring conductor 81. In the example illustrated in FIG. 10, the protruding-portion side surface 722b includes a first straight line portion 722c extending upward from the protruding-portion lower surface 722a and a second straight line portion 722d extending downward from the cover upper surface 72b. The second straight line portion 722d extends in the up-down direction Z in the cross section of the wiring conductor 81. The first straight line portion 722c is inclined toward the first wall portion 73 in the radial direction as it extends downward.

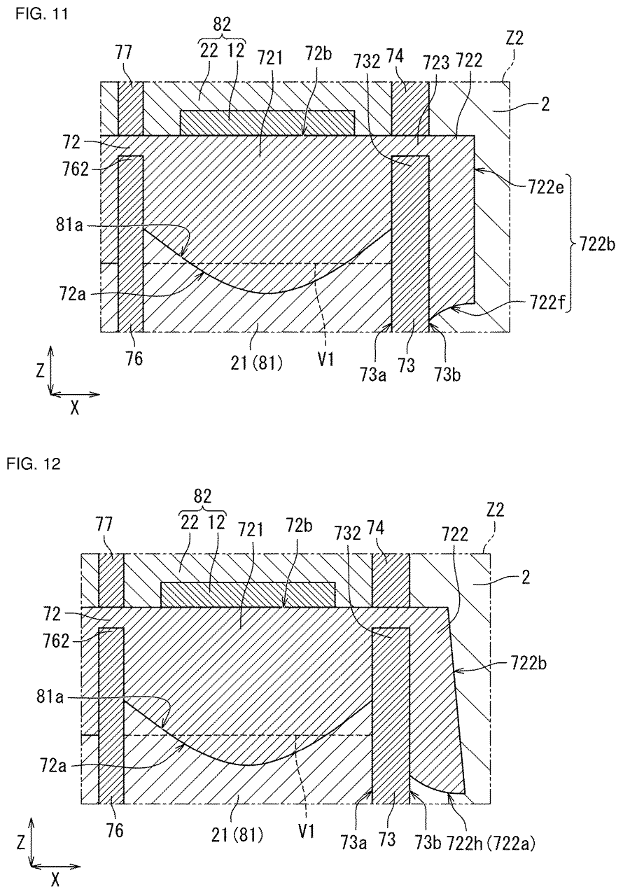

In a modification example illustrated in FIG. 11, the protruding-portion side surface 722b includes a straight line portion and a curved line portion in a cross section of the wiring conductor 81. In the example illustrated in FIG. 11, the protruding-portion side surface 722b includes a straight line portion 722e extending downward from the cover upper surface 72b and a curved line portion 722f extending in a downward direction from the lower end of the straight line portion 722e. The straight line portion 722e is inclined toward the first wall portion 73 in the radial direction as it extends downward. In the modification example illustrated in FIG. 11, the conductor upper surface 81a is curved to protrude downward.

In a modification example illustrated in FIG. 12, the protruding-portion lower surface 722a includes an inclined portion 722h inclined upward as it extends toward the first wall portion 73 in the radial direction in a cross section of the wiring conductor 81. In the example illustrated in FIG. 12, the entirety of the protruding-portion lower surface 722a is composed of the inclined portion 722h. Part of the magnetic body 2 is located between the inclined portion 722h and the outer wall surface 73b in the radial direction.

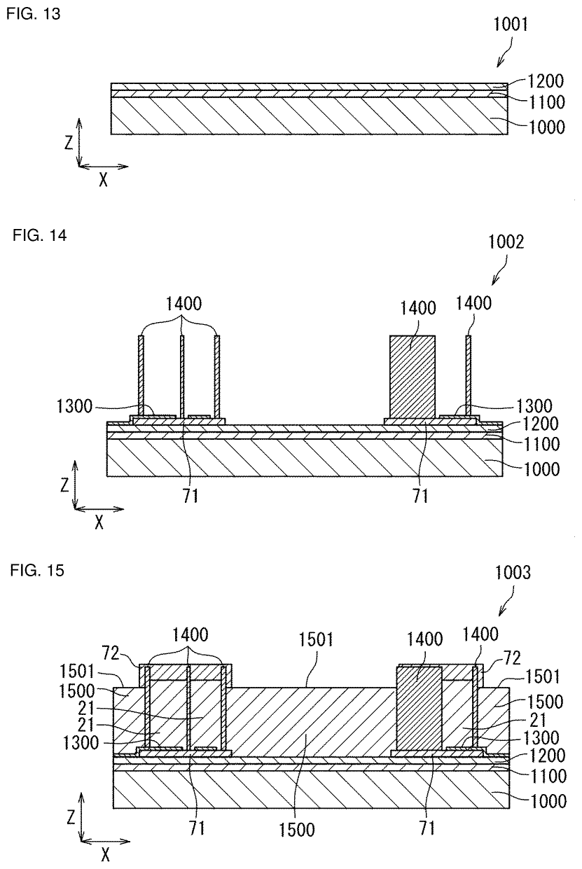

An example of a method of manufacturing the inductor component 1 will be described with reference to FIGS. 13 to 22. In the following description, description of the third conductor layer 13, the fourth conductor layer 14, the third inductor wire 23, and the fourth inductor wire 24 is omitted. FIGS. 13 to 22 are drawings corresponding to the cross section taken along line II-II in FIG. 1. In the manufacturing method illustrated in FIGS. 13 to 22, for example, a manufacturing apparatus for the inductor component 1 is used, and part or all of the steps are performed automatically.

As illustrated in FIGS. 13 and 14, the manufacturing apparatus forms the base insulation layer 71 on a first multilayer body 1001, which includes a substrate 1000 with an adhesive layer 1100 and a seed layer (conductor) 1200 laminated on the substrate 1000, and then forms a pattern seed 1300 extending over the base insulation layer 71 and the seed layer 1200 and forms a permanent resist 1400, so that a second multilayer body 1002 is formed. The pattern seed 1300 is used to form the first conductor layer 11. The base insulation layer 71 is formed by steps including, for example, lamination of an insulation layer, photolithography, and solidification. The pattern seed 1300 is formed by steps including, for example, sputtering (seed formation), resist lamination, photolithography, seed etching, and resist stripping. The permanent resist 1400 is formed by steps including, for example, permanent resist lamination, photolithography, and solidification. Part of the permanent resist 1400 is used to form the first wall portion 73.

As illustrated in FIG. 15, the manufacturing apparatus forms the first inductor wire 21 and a sacrificial copper portion 1500 simultaneously on the second multilayer body 1002 and then forms the cover insulation layer 72 on the first inductor wire 21. The first inductor wire 21 and the sacrificial copper portion 1500 are formed by steps including, for example, electrolytic plating (for example, electrolytic copper plating). In this process, a larger current is made to flow through the portions corresponding to the pad portions 818 than through the portion excluding the pad portions 818, which causes the plating to grow and the pad portions 818 to be thick. Alternatively, an additive may be used to promote the growth of plating in the pad portions 818. The cover insulation layer 72 is formed by steps including, for example, lamination of an insulation layer, photolithography, and solidification. In this process, in the step of photolithography, a magnetic path opening 1501 and the via conductors 51 and 52 are formed simultaneously. The via conductor 51 (see FIG. 9) having a tapered shape can be formed by, for example, adjusting the focus position in photolithography or laser processing. The shape of the protruding-portion side surface 722b illustrated in FIGS. 10 to 12 can be achieved by, for example, forming the cover insulation layer 72 by using a plurality of dry film resists. In this case, a plurality of dry film resists having different light absorption bands may be used.

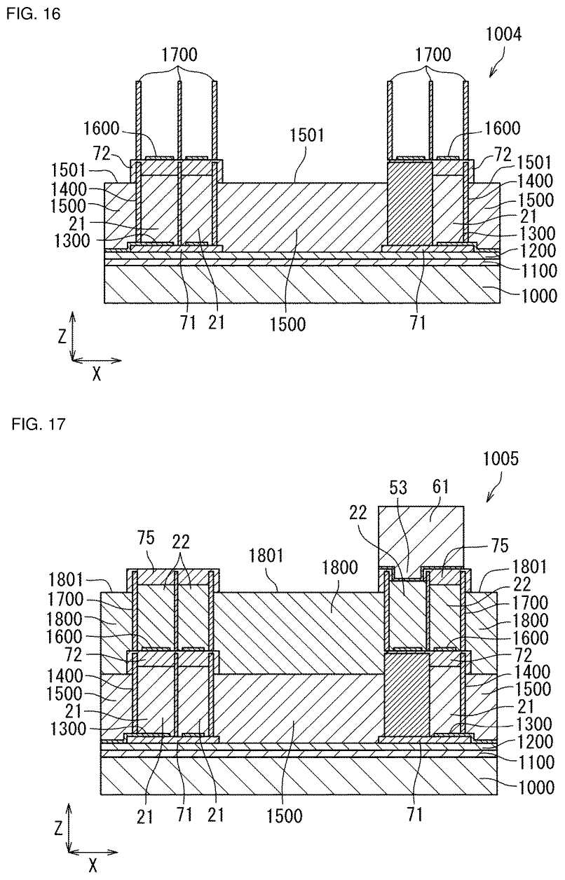

As illustrated in FIG. 16, the manufacturing apparatus forms a pattern seed 1600 and a permanent resist 1700 located on the cover insulation layer 72, on the third multilayer body 1003, so that a fourth multilayer body 1004 is formed. The pattern seed 1600 is used to form the second conductor layer 12. The pattern seed 1600 is formed by steps including, for example, sputtering (seed formation), resist lamination, photolithography, seed etching, and resist stripping. The permanent resist 1700 is formed by steps including permanent resist lamination, photolithography, and solidification. Part of the permanent resist 1700 is used to form the third wall portion 74.

The pattern seed 1600 may be formed of the same material as the pattern seed 1300 of the second multilayer body 1002 or may be formed of a material different from that of the pattern seed 1300. For the pattern seeds 1300 and 1600, an optimum material is selected for each layer. For example, in the case in which the pattern seed 1300 for the first layer is formed of a conductive material containing Ti, the adhesion to the base insulation layer 71 and the seed layer 1200 can be improved. In the case in which the pattern seed 1600 for the second layer is formed of the same conductive material (for example, only Cu) as the second inductor wire 22, the connection reliability to the via conductors 53 and 54 can be improved.

As illustrated in FIG. 17, the manufacturing apparatus forms the second inductor wire 22 and a sacrificial copper portion 1800 simultaneously on the fourth multilayer body 1004, then forms the upper cover insulation layer 75 on the second inductor wire 22, and forms the connection wire 61 on the upper cover insulation layer 75, so that a fifth multilayer body 1005 is formed. The second inductor wire 22 and the sacrificial copper portion 1800 are formed by steps including, for example, electrolytic plating (for example, electrolytic copper plating). The upper cover insulation layer 75 is formed by steps including, lamination of an insulation layer, photolithography, and solidification. In this case, in the step of photolithography, a magnetic path opening 1801 and the via conductors 53 and 54 are formed simultaneously. The connection wire 61 is formed by steps including, for example, sputtering (blanket seed formation), resist lamination, photolithography, electrolytic plating, resist stripping, and seed etching.

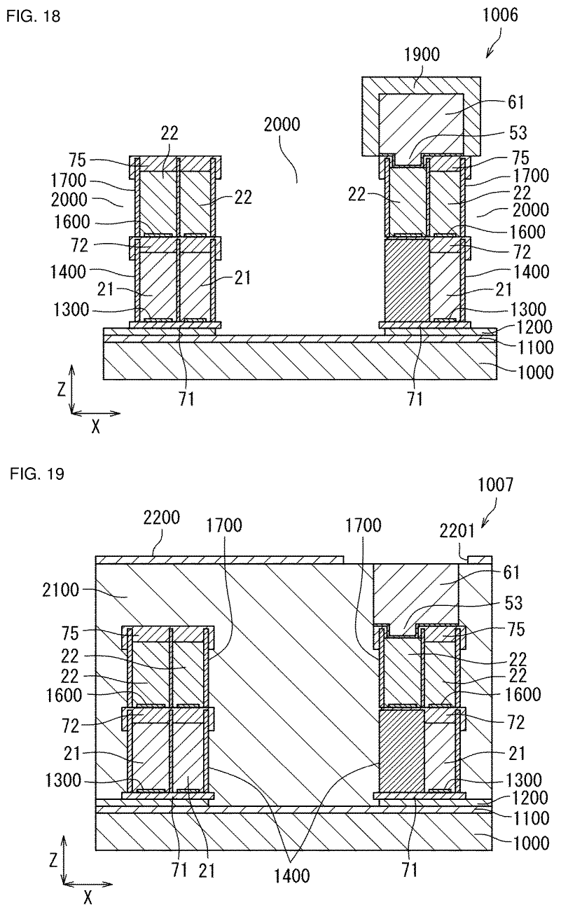

As illustrated in FIG. 18, the manufacturing apparatus forms a protective layer 1900 on the connection wire 61 of the fifth multilayer body 1005 and then removes the sacrificial copper portions 1500 and 1800 to form a magnetic path hole 2000, so that a sixth multilayer body 1006 is formed. The protective layer 1900 is formed by steps including, for example, resist lamination and photolithography. The removal of the sacrificial copper portions 1500 and 1800 is performed, for example, by etching. In the case in which the pattern seed 1300 for the first layer contains Ti, Ti etching is performed after Cu etching to leave part of the seed layer 1200.

As illustrated in FIG. 19, the manufacturing apparatus removes the protective layer 1900 of the sixth multilayer body 1006, then forms a magnetic layer 2100, and forms a solder resist (insulation layer) 2200 on the magnetic layer 2100, so that a seventh multilayer body 1007 is formed. The removal of the protective layer 1900 is performed by steps including, for example, resist stripping. The magnetic layer 2100 is formed by steps including, for example, pressing a magnetic material, solidification, and grinding. The grinding exposes the connection wire 61 to the outside. The magnetic layer 2100 is used to form part of the magnetic material. The solder resist 2200 is formed by steps including, for example, solder resist lamination, photolithography, and solidification. The solder resist 2200 has an opening 2201 for exposing the connection wire 61 to the outside. The solder resist 2200 is used to form the insulation layer 78.

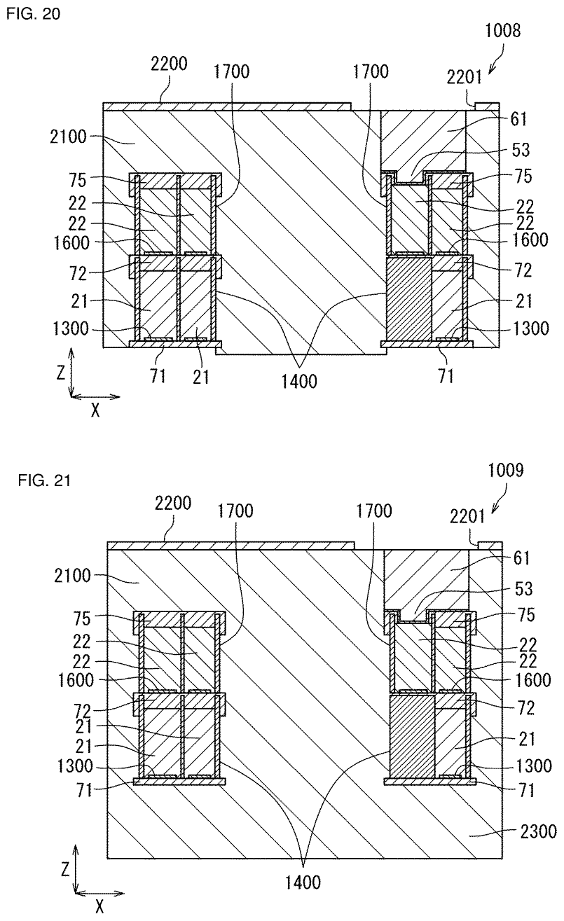

As illustrated in FIG. 20, the manufacturing apparatus removes the substrate 1000, the adhesive layer 1100, and the seed layer 1200 from the seventh multilayer body 1007, so that an eighth multilayer body 1008 is formed. The removal of the substrate 1000 and the adhesive layer 1100 is performed by, for example, mechanically stripping off the adhesive layer 1100. The removal of the seed layer 1200 is performed by, for example, wet etching or grinding. In the case in which the seed layer 1200 is removed by wet etching, part of the metal magnetic powder of the magnetic layer 2100 is etched, which makes the surface rough, so that the adhesion to a magnetic layer 2300 which is formed in the next step is improved.

As illustrated in FIG. 21, the manufacturing apparatus forms the magnetic layer 2300 on the eighth multilayer body 1008, so that a ninth multilayer body 1009 is formed. The magnetic layer 2300 is formed by steps including, for example, pressing a magnetic material, solidification, and grinding. The grinding is for adjusting the thickness of the magnetic body 2. Instead of grinding, the thickness of the magnetic body 2 may be adjusted by adjusting the degree of pressing when the magnetic layer 2300 is formed. The magnetic layer 2300 serves as part of the magnetic material.

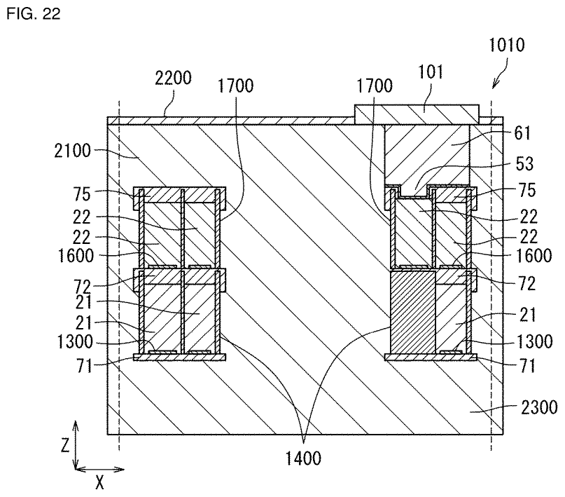

As illustrated in FIG. 22, the manufacturing apparatus forms the external terminal 101 on the ninth multilayer body 1009 to form a tenth multilayer body 1010, and then, separates the tenth multilayer body 1010 into individual pieces to form the inductor components 1 illustrated in FIG. 2. The external terminal 101 is formed by steps including, for example, sputtering (Cu seeding), resist lamination, photolithography, electrolytic plating, resist stripping, and seed etching. The separation into individual pieces is performed along, for example, the dashed lines illustrated in FIG. 22.

Instead of forming the external terminal 101, the exposed portion of the connection wire 61 may be used as an external terminal. In the case in which the external terminal 101 is formed in the opening 2201 of the solder resist 2200 and connected to the connection wire 61 as in the present aspect, the area of the external terminal 101 can be large, which improves the sticking force of the inductor component 1 to another device or the like. In addition, the external terminal 101 can be formed in any shape such as a protruding shape, which improves the degree of freedom in mounting the inductor component 1.

The external terminal 101 may be formed without forming the solder resist 2200. For example, as in the formation of the connection wire 61, the external terminal 101 may be formed by forming a blanket seed layer and then electrolytic plating. In this case, the external terminal 101 has a configuration the same as or similar to that of a Cu bump.

The inductor component 1 provides the following advantageous effects.

The inductor component 1 includes the base insulation layer 71 having the base upper surface 71a, the first wall portion 73, the second wall portion 76, the wiring conductor 81, the cover insulation layer 72, and the magnetic body 2. The first wall portion 73 is located on the base upper surface 71a and extends around the first turning axis A1 in the up-down direction Z. The second wall portion 76 is located on the base upper surface 71a and extends parallel to the first wall portion 73 around the first turning axis A1. The wiring conductor 81 is located on the base upper surface 71a between the first wall portion 73 and the second wall portion 76 and has the conductor upper surface 81a opposite in the up-down direction Z to the surface of the wiring conductor 81 in contact with the base insulation layer 71. The cover insulation layer 72 is laminated on the conductor upper surface 81a. The magnetic body 2 covers the base insulation layer 71, the first wall portion 73, the second wall portion 76, the wiring conductor 81, and the cover insulation layer 72. The cover insulation layer 72 includes the cover portion 721 overlapping the wiring conductor 81 in plan view and the protruding portion 722 located on the opposite side of the first wall portion 73 from the cover portion 721 in the radial direction. The thickness of the protruding portion 722 is greater than the thickness of the cover portion 721. Since the thickness of the cover portion 721 is less than the thickness of the protruding portion 722 in this configuration, the length in the up-down direction Z of the coil provided in the inductor component is longer. This makes the direct current resistance lower than in a configuration in which the thickness of the cover portion 721 is greater than the thickness of the protruding portion 722. However, in the case in which not only the cover portion 721 but also the protruding portion 722 are thin, the deformation resistance of the protruding portion 722 is low. This increases the possibility of deformation in the protruding portion 722 in manufacturing the inductor component 1. Since the thickness of the protruding portion 722 is greater than the thickness of the cover portion 721 in the configuration described above, the deformation resistance of the protruding portion 722 is less likely to be low, and the cover insulation layer 72 is less likely to be damaged. Hence, it is possible to reduce the direct current resistance while reducing damage to the cover insulation layer 72.

In addition, since the cover insulation layer 72 includes the protruding portion 722, the cover insulation layer 72 is formed to extend into the magnetic body 2 in the radial direction away from the wiring conductor 81. This improves the adhesion between the magnetic body 2 and the cover insulation layer 72 and between the magnetic body 2 and the wiring conductor 81 in contact with the cover insulation layer 72.

The thickness of the first wall portion 73 and the second wall portion 76 is greater than the thickness of the wiring conductor 81. Since the conductor upper surface 81a is located lower than the upper edge portions 732 and 762 in this configuration, the conductor upper surface 81a is covered more reliably with the first wall portion 73, the second wall portion 76, and the cover insulation layer 72. In addition, the thickness of the cover portion 721 can be greater than in a configuration in which the thickness of the first wall portion 73 and the second wall portion 76 is less than the thickness of the wiring conductor 81, improving the insulation between the wiring conductor 81 and the upper wiring conductor 82. This further reduces the degradation in the insulation for the wiring conductor 81.

The cover insulation layer 72 has the cover side surface 72c facing the radial direction and located closer to the second wall portion 76 than the outer wall surface 73b in the radial direction. In this configuration, the volume of the cover insulation layer 72 located around the wiring conductor 81 (for example, the first region B1 and the second region B2) can be smaller at positions different from that of the protruding portion 722. Accordingly, the volume of the magnetic body 2 can be larger by the amount corresponding to the reduction in the volume of the cover insulation layer 72. This reduces the magnetic resistance around the wiring conductor 81, further improving the inductance acquisition efficiency.

The cover upper surface 72b is smoother than the cover lower surface 72a. This configuration makes it easier to form the upper wiring conductor 82, the connection wire on the cover upper surface 72b, and the like than in a configuration in which the cover upper surface 72b is rougher than the cover lower surface 72a.

The cover portion 721 has the cover-portion lower surface 721a in contact with the wiring conductor 81. The protruding portion 722 has the protruding-portion lower surface 722a facing the base insulation layer 71 in the up-down direction Z. A surface roughness of the cover-portion lower surface 721a differs from a surface roughness of the protruding-portion lower surface 722a. Since the surface roughness of the cover-portion lower surface 721a and the surface roughness of the protruding-portion lower surface 722a can be adjusted in this configuration in consideration of the adhesion between the wiring conductor 81, the cover insulation layer 72, and the magnetic body 2, the degree of freedom in designing the inductor component 1 is high. For example, in the case in which the surface roughness of the cover-portion lower surface 721a is set to be greater than the surface roughness of the protruding-portion lower surface 722a, the contact area between the cover insulation layer 72 and the wiring conductor 81 is larger than in a configuration in which the surface roughness of the cover-portion lower surface 721a is less than the surface roughness of the protruding-portion lower surface 722a. This increases the adhesion between the cover insulation layer 72 and the wiring conductor 81.

The protruding portion 722 has the protruding-portion side surface 722b facing the radial direction. In an example, the protruding-portion side surface 722b includes the plurality of straight line portions 722c and 722d having different inclination angles in a cross section of the wiring conductor 81. In another example, the protruding-portion side surface 722b includes the straight line portion 722e and the curved line portion 722f in a cross section of the wiring conductor 81. In these configurations, the contact area between the protruding portion 722 and the magnetic body 2 is larger than in a configuration in which the protruding-portion side surface 722b is composed of one straight line portion in the cross section, improving the adhesion between the protruding portion 722 and the magnetic body 2.

The protruding-portion lower surface 722a includes the inclined portion 722h inclined upward as it extends toward the first wall portion 73 in the radial direction in a cross section of the wiring conductor 81. This configuration enables part of the magnetic body 2 to be located between the inclined portion 722h and the outer wall surface 73b in the radial direction. In other words, the protruding portion 722 extends downward into the magnetic body 2. This improves the adhesion between the magnetic body 2 and the cover insulation layer 72 and between the magnetic body 2 and the wiring conductor 81 in contact with the cover insulation layer 72.

The cover insulation layer 72 has the cover lower surface 72a facing the base insulation layer 71 in the up-down direction Z and the cover upper surface 72b opposite to the cover lower surface 72a. The inductor component 1 further includes the third wall portion 74 located on the cover upper surface 72b and extending around the second turning axis A2, the fourth wall portion 77 located on the cover upper surface 72b and extending parallel to the third wall portion 74 around the second turning axis A2, and the upper wiring conductor 82. The upper wiring conductor 82 has the upper-conductor upper surface 82a located on the cover upper surface 72b between the third wall portion 74 and the fourth wall portion 77 and opposite to the surface in contact with the cover insulation layer 72 in the up-down direction Z. The cover insulation layer 72 contains inorganic filler. The cover insulation layer 72 has a lower transparency than the first wall portion 73 and the second wall portion 76. The thickness of the cover portion 721 is less than the thickness of the first wall portion 73 and the thickness of the second wall portion 76. This configuration further including the upper wiring conductor 82 enables the coil of the inductor component 1 to be longer, improving the inductance acquisition efficiency. Since the cover insulation layer 72 contains inorganic filler, the insulation resistance and mechanical strength of the cover insulation layer 72 can be improved. This makes it possible to reduce the thickness of the cover insulation layer 72 while reducing the degradation in the insulation for the wiring conductor 81 and the degradation in the mechanical strength of the cover insulation layer 72, compared with a configuration in which the cover insulation layer 72 does not contain inorganic filler. In addition, since the thickness of the cover insulation layer 72 is less than the thickness of the first wall portion 73 and the second wall portion 76, the volume ratio of the cover insulation layer 72 to the inductor component 1 is smaller than in a configuration in which the thickness of the cover insulation layer 72 is greater than the thickness of the first wall portion 73 and the second wall portion 76. Accordingly, the volume of the magnetic body 2 can be larger by the amount corresponding to the reduction in the volume of the cover insulation layer 72. This reduces the magnetic resistance around the wiring conductor 81, improving the inductance acquisition efficiency. Since the cover insulation layer 72 has a lower transparency than the first wall portion 73 and the second wall portion 76, the wiring conductor 81 covered with the cover insulation layer 72 is less likely to be seen from the outside of the inductor component 1. This reduces the deterioration of the yield due to defects in terms of outer appearance that are less likely to affect the performance of the inductor component 1, such as a difference in the degree of oxidation of the wiring conductor 81.

The inductor component 1 further includes the external terminal 101 located on the main surface 202 of the magnetic body 2 and the connection wire 61 located in the magnetic body 2, extending in the up-down direction Z, and connecting the external terminal 101 to the wiring conductor (for example, the upper wiring conductor 82). An end portion of the wiring conductor in plan view has a pad portion (for example, the pad portion 828) connected to the connection wire 61. A configuration including the external terminal 101 on a side surface of the magnetic body 2 requires fillets. In contrast, the configuration described above includes the external terminal 101 on the main surface 202, and the external terminal 101 and the upper wiring conductor 82 are connected by the connection wire 61. This dispenses with the fillets and increases the number of members that can be placed in or on the magnetic body 2. In other words, the mounting density of the inductor component 1 is improved.

The cover portion 721 includes the first portion 724 in contact with the pad portion 818 in the up-down direction Z and the second portion 725 in contact with the portion of the wiring conductor 81 other than the pad portion 818 in the up-down direction Z. The thickness of the first portion 724 is less than the thickness of the second portion 725. Since the via conductor 51 connected to the pad portion 818 is located in the first portion 724 in this configuration, the via conductor 51 is thinner than in a configuration in which the pad portion 818 is thin, reducing the mechanical stress exerted on the via conductor 51. This reduces operational defects of the inductor component 1 due to damage to the via conductor 51. Since the via conductor 51 is thinner, it is possible to reduce the amount of residue produced when the via conductor 51 is formed, improving the connection strength of the via conductor 51.

The protruding portion 722 is located closer to the first turning axis A1 than the first wall portion 73 in the radial direction. The cover insulation layer 72 further includes the outward protruding portion 726 located on the opposite side of the first wall portion 73 from the cover portion 721 in the radial direction and located farther from the first turning axis A1 than the first wall portion 73. The thickness of the outward protruding portion 726 differs from the thickness of the protruding portion 722. In this configuration, the thickness of the protruding portion can be determined depending on whether the protruding portion is located in the first region B1 or the second region B2 of the magnetic body 2. This improves the degree of freedom in designing the inductor component 1.

The thickness of the protruding portion 722 is greater than the thickness of the outward protruding portion 726. In the first region B1 where magnetic flux is concentrated in the inductor component 1, the protruding portion 722 functions as an air gap. In the configuration described above, the air gap located in the first region B1 is larger than in a configuration in which the thickness of the protruding portion 722 is smaller than the thickness of the outward protruding portion 726. This enables the magnetic flux to be saturated more gently when the current flowing through the wiring conductor 81 increases. This improves the direct current bias characteristics of the inductor component 1.

The inductor component 1 further includes the upper cover insulation layer 75 laminated on the upper-conductor upper surface 82a. The upper cover insulation layer 75 includes the upper cover portion 751 overlapping the upper wiring conductor 82 in plan view and the upper protruding portion 752 located on the opposite side of the third wall portion 74 from the upper cover portion 751 in the radial direction. The thickness of the upper protruding portion 752 differs from the thickness of the protruding portion 722. In the case in which the inductor component 1 includes the upper wiring conductor 82, the magnetic body 2 is thicker than in a configuration without the upper wiring conductor 82, and the mechanical strength of the inductor component 1 tends to be lower. In this configuration, the protruding portion 722 and the upper protruding portion 752 are both provided to extend into the magnetic body 2 in the radial direction. This improves the adhesion between the magnetic body 2 and each of the cover insulation layer 72, the wiring conductor 81, the upper cover insulation layer 75, and the upper wiring conductor 82, improving the mechanical strength of the inductor component 1. In addition, since the thickness of the protruding portion 722 and the upper protruding portion 752 can be determined in the configuration described above in consideration of the characteristics of the inductor component 1, insulation for the wiring conductors 81 and 82, the deformation resistance of the protruding portion 722 and the upper protruding portion 752, and other conditions, the degree of freedom in designing the inductor component 1 is high.

The thickness of the upper protruding portion 752 is greater than the thickness of the protruding portion 722. In manufacturing the inductor component 1, the magnetic material composing the magnetic body 2 is press-fitted, for example, downward. In this process, the upper protruding portion 752 located at a high position receives a higher mechanical stress than the protruding portion 722 located at a low position. Since the thickness of the upper protruding portion 752 is greater than the thickness of the protruding portion 722 in the configuration described above, the deformation resistance of the upper protruding portion 752 is higher than the deformation resistance of the protruding portion 722. This reduces damage to the upper cover insulation layer 75 in manufacturing the inductor component 1.

The portion of the cover insulation layer 72 between the first wall portion 73 or the second wall portion 76 and the third wall portion 74 or the fourth wall portion 77 in the up-down direction Z (for example, the intermediate portion 723) includes the portion of the cover insulation layer 72 having a least thickness. The portions of the cover insulation layer 72 between two of the wall portions 73, 76, 74, and 77 on the upper and lower sides have high insulation. In such portions, the thickness of the cover insulation layer 72 can be reduced, so that it is possible to reduce the volume of the cover insulation layer 72 while reducing the degradation in the insulation for the wiring conductor 81. Accordingly, the volume of the magnetic body 2 can be larger by the amount corresponding to the reduction in the volume of the cover insulation layer 72. This reduces the magnetic resistance around the wiring conductor 81, improving the inductance acquisition efficiency. Thus, it is possible to improve the inductance acquisition efficiency while reducing the degradation in the insulation for the wiring conductor.

The inductor component 1 may include wiring conductor layers, each located on one of three or more imaginary planes parallel to one another. In this case, the inductor component 1 may also include three or more insulation layers. The inductor component 1 need not include the third wall portion 74, the fourth wall portion 77, the upper wiring conductor 82, and the upper cover insulation layer 75.

The base upper surface 71a and the cover upper surface 72b may each have one conductor layer or three or more conductor layers.

The shape and size of each constituent of the inductor component 1 are not limited to those in the aspect described above but may be set in any shape and size depending on the design and other conditions of the inductor component 1. For example, the thickness of the first conductor layer 11 of the inductor component 1 is not limited to being less than 1.0 μm and less than 1/100 of the thickness of the first inductor wire.

Each inductor wire need only to have a spiral shape when viewed in the up-down direction Z. For example, each inductor wire may form a curved line with one or more turns, or may form a curved line with less than one full turn. Each inductor wire may have a straight line shape in part.

Although in the description of the embodiment, the upper wiring conductor 82 corresponds to an “upper wiring conductor” in the present disclosure, the present disclosure is not limited to this configuration. For example, the upper wiring conductor 82 can be an example of a “wiring conductor” in the present disclosure. In this case, the third wall portion 74 corresponds to a “first wall portion” in the present disclosure, and the fourth wall portion 77 corresponds to a “second wall portion” in the present disclosure. The cover insulation layer 72 corresponds to a “base insulation layer” in the present disclosure, and the upper cover insulation layer 75 corresponds to a “cover insulation layer” in the present disclosure.

As for the embodiments and the modification examples of the present disclosure, combinations of embodiments, combinations of modification examples, and combinations of embodiments and modification examples are possible. Features included in embodiments and modification examples in the present disclosure may also be combined.

It is natural that details of the configuration in the present disclosure can be changed. Combinations of elements or the order of elements in each embodiment can be changed without departing from the claimed scope and spirit of the present disclosure.

Since the present disclosure reduces the direct current resistance while reducing damage to the cover insulation layer, the present disclosure is useful for various kinds of inductor components.

What is claimed is:

1. An inductor component comprising:
a base insulation layer having a base upper surface;
a first wall portion on the base upper surface and extending around a turning axis in an up-down direction intersecting the base upper surface;
a second wall portion on the base upper surface and extending parallel to the first wall portion around the turning axis;
a wiring conductor on the base upper surface between the first wall portion and the second wall portion and having a conductor upper surface opposite in the up-down direction to a surface of the wiring conductor in contact with the base insulation layer;
a cover insulation layer laminated on the conductor upper surface; and
a magnetic body covering the base insulation layer, the first wall portion, the second wall portion, the wiring conductor, and the cover insulation layer, wherein
the cover insulation layer includes
a cover portion overlapping the wiring conductor in a plan view in the up-down direction, and
a protruding portion on an opposite side of the first wall portion from the cover portion in a radial direction of the turning axis, and
a thickness of the protruding portion, the thickness being a dimension in the up-down direction, is greater than a thickness of the cover portion.

2. The inductor component according to claim 1, wherein
a thickness of the first wall portion and a thickness of the second wall portion is greater than a thickness of the wiring conductor.

3. The inductor component according to claim 1, wherein
the first wall portion has an inner wall surface in contact with the wiring conductor and an outer wall surface opposite to the inner wall surface and in contact with the magnetic body, and
the cover insulation layer has a cover side surface facing the radial direction and located closer to the second wall portion than the outer wall surface in the radial direction.

4. The inductor component according to claim 1, wherein
the cover insulation layer has a cover lower surface facing the base insulation layer in the up-down direction and a cover upper surface opposite to the cover lower surface, and
the cover upper surface is smoother than the cover lower surface.

5. The inductor component according to claim 4, wherein
the cover portion has a cover-portion lower surface in contact with the wiring conductor,
the protruding portion has a protruding-portion lower surface facing the base insulation layer in the up-down direction, and
a surface roughness of the cover-portion lower surface differs from a surface roughness of the protruding-portion lower surface.

6. The inductor component according to claim 1, wherein
the protruding portion has a protruding-portion side surface facing the radial direction, and
the protruding-portion side surface includes a plurality of straight line portions having different inclination angles in a cross section intersecting an extending direction of the wiring conductor.

7. The inductor component according to claim 1, wherein
the protruding portion has a protruding-portion side surface facing the radial direction, and
the protruding-portion side surface includes a straight line portion and a curved line portion in a cross section intersecting an extending direction of the wiring conductor.

8. The inductor component according to claim 1, wherein
the protruding portion has a protruding-portion lower surface facing the base insulation layer in the up-down direction, and
the protruding-portion lower surface includes an inclined portion inclined upward as the inclined portion extends toward the first wall portion in the radial direction in a cross section intersecting an extending direction of the wiring conductor.

9. The inductor component according to claim 1, wherein
the cover insulation layer has a cover lower surface facing the base insulation layer in the up-down direction and a cover upper surface opposite to the cover lower surface,
the inductor component further comprises:
a third wall portion on the cover upper surface and extending around the turning axis;
a fourth wall portion on the cover upper surface and extending parallel to the third wall portion around the turning axis; and
an upper wiring conductor on the cover upper surface between the third wall portion and the fourth wall portion and having an upper-conductor upper surface opposite in the up-down direction to a surface of the upper wiring conductor in contact with the cover insulation layer,
the cover insulation layer includes inorganic filler,
the cover insulation layer has a lower transparency than the first wall portion and the second wall portion, and
a thickness of the cover insulation layer is less than a thickness of the first wall portion and a thickness of the second wall portion.

10. The inductor component according to claim 1, further comprising:
an external terminal on an outer surface of the magnetic body; and
a connection wire in the magnetic body, extending in the up-down direction, and connecting the external terminal to the wiring conductor, wherein
a pad portion connected to the connection wire is at an end portion of the wiring conductor in the plan view.

11. The inductor component according to claim 10, wherein
the cover portion includes
a first portion in contact with the pad portion in the up-down direction and
a second portion in contact with a portion of the wiring conductor other than the pad portion in the up-down direction, and
a thickness of the first portion is less than a thickness of the second portion.

12. The inductor component according to claim 1, wherein
the protruding portion is closer to the turning axis than the first wall portion in the radial direction,
the cover insulation layer further includes an outward protruding portion on an opposite side of the first wall portion from the cover portion in the radial direction and located farther from the turning axis than the first wall portion, and
a thickness of the outward protruding portion differs from a thickness of the protruding portion.

13. The inductor component according to claim 12, wherein
the thickness of the protruding portion is greater than the thickness of the outward protruding portion.

14. The inductor component according to claim 1, wherein
the cover insulation layer has a cover lower surface facing the base insulation layer in the up-down direction and a cover upper surface opposite to the cover lower surface,
the inductor component further comprises:
a third wall portion on the cover upper surface and extending around the turning axis;
a fourth wall portion on the cover upper surface and extending parallel to the third wall portion around the turning axis;
an upper wiring conductor on the cover upper surface between the third wall portion and the fourth wall portion and having an upper-conductor upper surface opposite in the up-down direction to a surface of the upper wiring conductor in contact with the cover insulation layer; and
an upper cover insulation layer laminated on the upper-conductor upper surface,
the upper cover insulation layer includes
an upper cover portion overlapping the upper wiring conductor in the plan view and
an upper protruding portion on an opposite side of the third wall portion from the upper cover portion in the radial direction, and
a thickness of the upper protruding portion differs from a thickness of the protruding portion.

15. The inductor component according to claim 14, wherein
the thickness of the upper protruding portion is greater than the thickness of the protruding portion.

16. The inductor component according to claim 1, wherein
the cover insulation layer has a cover lower surface facing the base insulation layer in the up-down direction and a cover upper surface opposite to the cover lower surface,
the inductor component further comprises:
a third wall portion on the cover upper surface and extending around the turning axis;
a fourth wall portion on the cover upper surface and extending parallel to the third wall portion around the turning axis; and
an upper wiring conductor on the cover upper surface between the third wall portion and the fourth wall portion and having an upper-conductor upper surface opposite in the up-down direction to a surface of the upper wiring conductor in contact with the cover insulation layer, and
in the cover insulation layer, a portion between the first wall portion or the second wall portion and the third wall portion or the fourth wall portion in the up-down direction includes a portion of the cover insulation layer having a least thickness.

17. The inductor component according to claim 2, wherein
the first wall portion has an inner wall surface in contact with the wiring conductor and an outer wall surface opposite to the inner wall surface and in contact with the magnetic body, and
the cover insulation layer has a cover side surface facing the radial direction and located closer to the second wall portion than the outer wall surface in the radial direction.

18. The inductor component according to claim 2, wherein
the cover insulation layer has a cover lower surface facing the base insulation layer in the up-down direction and a cover upper surface opposite to the cover lower surface, and
the cover upper surface is smoother than the cover lower surface.

19. The inductor component according to claim 2, wherein
the protruding portion has a protruding-portion side surface facing the radial direction, and
the protruding-portion side surface includes a plurality of straight line portions having different inclination angles in a cross section intersecting an extending direction of the wiring conductor.

20. The inductor component according to claim 2, wherein
the protruding portion has a protruding-portion side surface facing the radial direction, and
the protruding-portion side surface includes a straight line portion and a curved line portion in a cross section intersecting an extending direction of the wiring conductor.
